(19) United States
(12) Patent Application Publication
(10) Pub. No.: US 2024/0381879 A1
(43) Pub. Date: Nov. 21, 2024

(54) SEASONED PRETZEL CRUMBS/BITS AND PROCESS OF MAKING THE SAME

(71) Applicant: Karl Brown, Flourtown, PA (US)

(72) Inventor: Karl Brown, Flourtown, PA (US)

(21) Appl. No.: 18/320,980

(22) Filed: May 21, 2023

(51) Int. Cl. A21D 13/40

(52) U.S. Cl. CPC A21D 13/40

(57) ABSTRACT

A food topping made of small sized seasoned pretzel crumbs/bits, and a process of making the same. The process can include milling whole hard pretzels, sifting the milled crumbs/bits of pretzels to be within a size of 0.1 to 0.350 inches, forming a slurry of cooking oil and seasoning, and then mixing the 0.1 to 0.350 inch pretzel crumbs/bits and slurry until the pretzel crumbs/bits are seasoned on the inside and outside thereof.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### Field of the Invention

The present inventive concept relates to a food topping formed of seasoned pretzel crumbs/bits, and a process of making the same. More particularly, but not exclusively, this inventive concept relates to a food topping formed of seasoned pretzel crumbs/bits, and a process of making the same, such that the seasoned pretzel crumbs/bits are formed by milling pretzels to a specific size using a specific milling machine and further sifting the bits to conform to specific size parameters and seasoning the specific size crumbs/bits through a unique process.

### Description of the Related Art

US Publication No. 2009/0017169 discloses a method for making a hard pretzel product that effectively absorbs a seasoning slurry. Once dough strands are formed, cut and baked such that a portion of produced pretzel sticks (stress fractures 550) have a surface area that is not covered by a hard shell. These portions of the pretzel sticks that are exposed from the hard shell are relied on to absorb a seasoning slurry. However, these finished seasoned pretzel sticks are limited by their large size to being used for snacks and cannot be used for toppings on other

Korean Patent No. 20170034263A discloses a method of manufacturing pretzel cookies. Here a temperature control step of preheating a prepared pretzel at a temperature of 40 to 60 degrees C. for 8 to 24 hours or at a temperature of 70 to 80 degrees C. for 10 to 20 minutes expands the pores formed therein. A softening step of spraying a liquid binder onto the thermally controlled pretzel and applying the liquid binder to the surface and impregnating the applied liquid binder into the pores to soften the texture of the piece of pretzel is used. A tumbler or mixing container is then filled with the softened pretzel pieces and honeycomb powder, honey powder, cheese powder, flavor, dye, seasoning, oil, garlic powder, and at least one seasoning ingredient selected from honey and butter, where tumbling the mixture helps adhere the mixture to the surface of the softened pretzel pieces. However, these finished seasoned pretzel sticks are limited to being used for snacks due to their large size and cannot be used for toppings on other foods.

Accordingly, there is a need for food toppings formed of small size seasoned pretzel crumbs/bits.

There is also a need for food toppings formed of small size seasoned pretzel crumbs/bits that can be sprinkled on other foods.

### SUMMARY OF THE INVENTIVE CONCEPT

The present general inventive concept provides a food topping formed of seasoned pretzel crumbs/bits, and a process of making the same. More particularly, but not exclusively, this inventive concept relates to a food topping formed of seasoned pretzel crumbs/bits, and a process of making the same, such that the seasoned pretzel crumbs/bits are formed by milling pretzels to a specific size using a specific milling machine, sifting the resulting product to conform to specific size targets and seasoning the specific size crumbs/bits through a unique process.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a process of making a food topping of seasoned pretzel crumbs/bits, the process comprising: milling whole hard pretzels to small size pieces; sifting the small pretzel crumbs/bits to sizes between 0.1 to 0.350 inches; forming a slurry of cooking oil and seasoning by mixing the cooking oil and seasoning together; and mixing the 0.1 to 0.350 inch pretzel crumbs/bits and slurry together for a predetermined period of time until the 0.1 to 0.350 inch pretzel pieces are seasoned internally and externally.

In an exemplary embodiment, after the sifting step any pretzel crumbs/bits larger than 0.1 to 0.350 inches are fed back through the milling step.

In another exemplary embodiment, a ratio of the slurry and pretzel crumbs/bits being mixed is 50:50.

In another exemplary embodiment, the slurry is formed by mixing equal parts of cooking oil and seasoning.

In still another exemplary embodiment, the 0.1 to 0.350 inch pretzel crumbs/bits and slurry are tumbled for a time period between four and ten minutes.

The foregoing and/or other features and utilities of the present general inventive concept may be achieved by providing a food topping of seasoned pretzel crumbs/bits formed by steps including: milling whole hard pretzels to small size crumbs/bits; sifting the small pretzel crumbs/bits to sizes between 0.1 to 0.350 inches; forming a slurry of cooking oil and seasoning by mixing the cooking oil and seasoning together; and mixing the 0.1 to 0.350 inch pretzel crumbs/bits and slurry together for a predetermined period of time until the 0.1 to 0.350 inch pretzel crumbs/bits are seasoned internally and externally.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 is a flowchart illustrating a process of making seasoned pretzel crumbs/bits according to an example embodiment of the present inventive concept.

The drawings illustrate a few exemplary embodiments of the present inventive concept and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

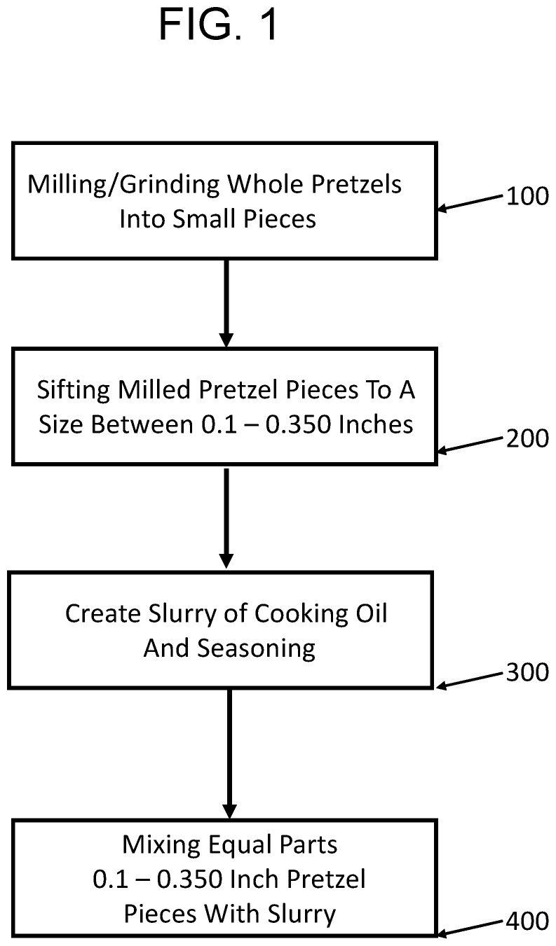

Exemplary embodiments of the present general inventive concept are directed to a food topping formed of seasoned pretzel crumbs/bits, and a process of making the same. The process of making a food topping formed of seasoned pretzel pieces crumbs/bits will be described with reference to FIG. 1.

Referring to FIG. 1, in accordance with an example embodiment of the present inventive concept, whole hard baked pretzels are fed through a specifically designed milling machine to be milled to small crumbs/bits at step 100, such as the FITSPATRICK milling machine model 15681. The whole hard baked pretzels are conveyed into the milling machine, where grinding teeth within the milling machine will grind the baked pretzels to much smaller, yet inconsistent size crumbs/bits. These much smaller yet inconsistent size crumbs/bits can then be conveyed to a sifter device/machine at step 200, which will sift the small crumbs/bits to be consistent within a narrow range of 0.1-0.350 inches in size. A preferred sifter machine to be used is the SAKEN electric vibrating sifter machine (SIFT-600-30). Any crumbs/bits larger than 0.1-0.350 inches can be re-introduced to the milling machine at step 100 for further reduction in size. Any pretzel crumbs/bits smaller than 0.1-0.350 inches can be removed from the collection of sifted 0.1-0.350 inch pretzel crumbs/bits and disposed of. The size of the sifted crumbs/bits is important in order to obtain a specific mouthfeel and flavor. The milled and sifted pretzel crumbs/bits will vary in shape, where the smaller pretzel crumbs/bits tend to be granular and symmetrical and the larger flatter pretzel crumbs/bits are similar to small flakes.

Once pretzel crumbs/bits only within a range of 0.1-0.350 inches are collected into a batch, these pretzel crumbs/bits can be added to a uniquely formed slurry. In step 300 this uniquely formed slurry can be produced by combining a cooking oil (preferably canola oil or sunflower oil) with a dry seasoning. In an example embodiment, a ratio of the cooking oil to seasoning can be 50:50. The dry seasoning can be a sweet or savory spice(s) to add a specifically desired flavor dimension. At step 400 this slurry of equal parts cooking oil and seasoning can then be introduced into an industrial mixer (aka: a tumbler) machine with the batch of pretzel crumbs/bits having a size between 0.1-0.350 inches. In an example embodiment, a ratio of pretzel crumbs/bits, cooking oil and seasoning is preferably 50% pretzel pieces, 25% cooking oil and 25% seasoning. It is to be noted that this ratio of pretzel crumbs/bits, cooking oil and seasoning can be varied depending on the flavor desired or depending on the intended application of the finished product. The slurry and batch of pretzel crumbs/bits can then be spun together in the mixer (step 400) to coat the seasoning into and onto the pretzel crumbs/bits over a time period of 4-10 minutes per cycle (the length of one cycle will depend on the flavor profile desired as well as the viscosity of the seasoning). A STOKES 300VS coating pan mixer is one type of mixer that can be used for seasoning this type of product. The milled and sifted pretzel crumbs/bits, being made from whole hard pretzels, will have exposed porous bread-like centers of the pretzels, which enables the slurry of cooking oil and seasoning to adhere to and be absorbed by the small pretzel crumbs/bits.

The finished product results in a robust, highly flavorful batch of specifically sized (between 0.1-0.350 inches) food topping pretzel crumbs/bits due to the unique milling (aka: grinding) process, which breaks down the hard pretzel shells and creates a surface that is much more receptive for flavoring. The above-described processed pretzel crumbs/bits according to the present inventive concept are much smaller and more flavorful than anything previously available. Also, the pretzel crumbs/bits according to the present inventive concept provide a much different range of uses than any standard ready-to-eat products on the market, such as being used as a salad topper, as a topping for baked potatoes, as a topping for vegetables, as a topping for casseroles, as a topping for ice cream, as a topping for soups, as a topping for stews, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A process of making a food topping of seasoned pretzel crumbs/bits, the process comprising:
milling whole hard pretzels to small crumbs/bits;
sifting the small pretzel crumbs/bits to sizes between 0.1 to 0.350 inches;
creating a slurry of equal parts cooking oil and seasoning; and
mixing the 0.1 to 0.350 inch pretzel crumbs/bits and slurry together for a predetermined period of time until the 0.1 to 0.350 inch pretzel crumbs/bits are seasoned internally and externally.

2. The process according to claim 1, wherein after the sifting step any pretzel crumbs/bits larger than 0.1 to 0.350 inches are fed back through the milling step.

3. The process according to claim 1, wherein a ratio of the slurry and pretzel crumbs/bits being mixed 50:50.

4. The process according to claim 1, wherein the slurry is formed by mixing equal parts of cooking oil and seasoning.

5. The process according to claim 1, wherein the 0.1 to 0.350 inch pretzel crumbs/bits and slurry are mixed for a time period between four and ten minutes.

6. The process according to claim 5, wherein the 0.1 to 0.350 inch pretzel crumbs/bits and slurry are mixed in an industrial sized mixing machine.

7. A food topping of seasoned pretzel crumbs/bits formed by steps including:
milling whole hard pretzels to small size crumbs/bits;
sifting the small pretzel crumbs/bits to sizes between 0.1 to 0.350 inches;
forming a slurry of cooking oil and seasoning by mixing the cooking oil and seasoning together; and
mixing the 0.1 to 0.350 inch pretzel crumbs/bits and slurry together for a predetermined period of time until the 0.1 to 0.350 inch pretzel crumbs/bits are seasoned internally and externally.
